(19) United States
(12) Patent Application Publication
(10) Pub. No.: US 2026/0328601 A1
(43) Pub. Date: Oct. 22, 2026

(54) CLAMP-ON TYPE ULTRASONIC FLOW METERS

(71) Applicant: UNITED BENEFIT CORP, New Taipei City (TW)

(72) Inventor: Yuan Hse CHANG, New Taipei City (TW)

(21) Appl. No.: 19/637,359

(22) Filed: Apr. 2, 2026

(30) Foreign Application Priority Data
Apr. 16, 2025 (TW) 114114465

(51) Int. Cl. G01F 1/66; G01F 1/667

(52) U.S. Cl. CPC G01F 1/662; G01F 1/667

(57) ABSTRACT

Disclosed is a clamp-on ultrasonic flow meter including a clamp part, a mounting case, a main unit and fixing elements, wherein the clamping part is configured to receive a pipeline, the mounting case includes guide structures and through holes, the clamping part connected to the mounting case is configured to surround the pipeline and move axially, circumferentially or radially along a pipeline, the main unit includes sliding structures and an ultrasonic probe and can be embedded into the mounting case by aligning the sliding structures with the guide structures, the fixing elements can pass through the through holes from upper side of the mounting case to push the main unit to move towards the clamping part, to allow a lower surface of the ultrasonic probe and the clamping part to clamp surface of the pipeline, thereby fixing the main unit on the pipeline.

### BACKGROUND OF THE INVENTION

### 1. Field of the Invention

The present application is related to a flow meter, more particularly related to a clamp-on ultrasonic flow meter installed on a surface of a pipeline.

### 2. The Prior Arts

Manufacturing plants are equipped with a large number of pipelines for transporting materials. In response to the requirements of industrial upgrading, real-time monitoring of the state of materials within pipelines has become an essential task. Ultrasonic flow meters can be installed on the surface of a pipeline by using a clamp, allowing for the measurement of the flow rate and volume of the fluid within the pipeline without damaging the pipeline. Consequently, an increasing number of manufacturers are adopting ultrasonic flow meters to monitor the state of materials inside their pipelines.

A pair of ultrasonic probes of an ultrasonic flow meter must be precisely installed at relative positions on the outer surface of a pipeline to minimize errors in receiving ultrasonic signals, wherein the relative positions between the ultrasonic probes correlate with the inner diameter of the pipeline. Previously, the method for installing the ultrasonic flow meter includes placing the ultrasonic probes on a clamp or a carrier; then, securing the clamp or the carrier to the surface of the pipeline by using fixing elements such as screws or straps; and, calibrating the spacing between the ultrasonic probes based on the pipeline diameter and the ultrasonic transmission/reception signals. Such a design and installation method require professional technicians to be completed correctly.

For installation convenience, manufacturers have developed clamp-on ultrasonic flow meters for the outer surfaces of pipelines that are compatible with specific pipeline diameter ranges and eliminate the need to adjust the spacing between ultrasonic probes. Such a clip-on ultrasonic flow meter includes a two-piece clamp and a main unit equipped with a pair of ultrasonic probes. The installation method includes clamping the two-piece clamp onto the surface of the pipeline from opposite directions, followed by tightening screws to reduce the clearance of the two-piece clamp, thereby securing the two-piece clamp onto the pipeline surface. Subsequently, the main unit is screwed into one of the parts of the two-piece clamp until an acoustic coupling layer on the surface of the ultrasonic probes is in close contact with the pipeline surface. Since the two-piece clamp is pre-configured for installation on pipelines within a specific diameter range, and the spacing of the ultrasonic probes within the main unit already corresponds to that range, installers typically do not need to calibrate the spacing of the ultrasonic probes within the carrier once the two-piece clamp and the main unit was secured to the pipeline surface.

During the installation process of the aforesaid clamp-on ultrasonic flow meter, uneven or excessive force applied by the screws can easily cause the two-piece clamp, the main unit, or the ultrasonic probes to tilt or warp (e.g., localized depressions on one or both sides along the radial direction of the pipeline) that prevents the ultrasonic probes within the main unit from staying in close contact with the pipeline surface or being accurately aligned along the same axis of the pipeline, which not only leads to erroneous measurement data but may also damage the clip-on ultrasonic flow meter. Furthermore, manufacturing plants often have a high density of pipelines with limited space between pipelines, creating environments where many existing clamp-on ultrasonic flow meters cannot be installed.

Accordingly, improving the ease of installation and the measurement accuracy of clamp-on ultrasonic flow meters are the primary aspects of the present application.

### SUMMARY OF THE INVENTION

To achieve the aforesaid aspects, the present application provides a clamp-on ultrasonic flow meter including a clamping part, a mounting case, a main unit and fixing elements. The clamping part is configured to receive a pipeline. The mounting case is detachably connected to the clamping part and includes guide structures and through holes, wherein the clamping part connected to the mounting case surrounds the pipeline and can move axially, circumferentially or radially along the pipeline. The main unit includes sliding structures and an ultrasonic probe and can be embedded into the mounting case by aligning the sliding structures with the guide structures. The fixing elements can pass through the through holes from an upper side of the mounting case to push the main unit to move towards the clamping part, to allow a lower surface of the ultrasonic probe and the clamping part to clamp the surface of the pipeline, thereby fixing the main unit on the pipeline.

In an embodiment, the clamping part includes vertical walls and a base connected to the vertical walls, a distance between the vertical walls is not less than an outer diameter of the pipeline, the base has a centerline and two inclined or arcuate surfaces symmetrical to the centerline, and the pipeline abuts against the two inclined or arcuate surfaces.

In an embodiment, the mounting case further includes a frame, the guide structures are located at two opposite inner sides of the frame, and each of the guide structures includes two grooves, each of the through holes is located between the two grooves, and each of the sliding structures includes two protrusions that align the two grooves.

In an embodiment, the main unit includes a housing, a probe seat connected to a lower side of the housing, and stoppers located at two opposite outer sides of the probe seat, the ultrasonic probe is disposed in the probe seat, and the fixing elements pass through the through holes from upper side of the mounting case and embed into the stoppers.

In an embodiment, the fixing elements are screw-locking components.

In an embodiment, the clamping part is connected to the mounting case by screw-locking or snap-fit.

In an embodiment, a distance of the fixing element passing through the through hole is inversely proportional to an outer diameter of the pipeline.

In an embodiment, the ultrasonic probe has an acoustic impedance coupling layer on the lower surface thereof.

In an embodiment, the clamp-on ultrasonic flow meter further includes a circuit board, a power and signal cable, and an outer cover, wherein the circuit board is disposed in the main unit, connected to the ultrasonic probe and can control the ultrasonic probe transmit and receive sensing signals; the power and signal cable is connected to the circuit board and can supply an outer power to the circuit board; the outer cover is disposed on the main unit and capable of restricting a distance that the main unit moves towards the clamping part.

In an embodiment, the clamp-on ultrasonic flow meter further includes a display, disposed on the main unit and connected to the circuit board, for displaying a flow velocity and a flow rate of the liquid in the pipeline.

In the clamp-on ultrasonic flow meter of the present application, the clamping part is configured to receive a pipeline, and the mounting case is detachably connected to the clamping part; once connected, the clamping part and the mounting case surround the pipeline and are movable in an axial, circumferential, or radial direction of the pipe without applying any mechanical force to the pipeline. The main unit is embedded into the mounting case by aligning a sliding structure of the main unit with a guide structure of the mounting case. The fixing element pushes the main unit such that a lower surface of an ultrasonic probe in the main unit and the clamping part clamp the surface of the pipe therebetween. There is no torque between the fixing element and the main unit, which effectively prevents deformation of the main unit or the pipeline caused by over-tightening of the clamping part, the mounting case, and the fixing element, while significantly enhancing the installation convenience and measurement accuracy of the clamp-on ultrasonic flow meter.

### BRIEF DESCRIPTION OF THE DRAWINGS

FIG. 1A is a perspective view illustrating a clamp-on ultrasonic flow meter of an embodiment of the present application,

FIG. 1B is an exploded view illustrating the clamp-on ultrasonic flow meter as shown in FIG. 1A,

FIG. 1C is a cross-sectional view illustrating the clamp-on ultrasonic flow meter as shown in FIG. 1A along the radial direction of the pipeline,

FIG. 2 that is a side view illustrating the clamping part 11′ and the mounting case 12′ of the other embodiment,

FIG. 3A is a perspective view illustrating a clamp-on ultrasonic flow meter according to another embodiment of the present application, and

FIG. 3B is a cross-sectional view illustrating the clamp-on ultrasonic flow meter shown in FIG. 3A along an axial direction of a pipeline.

### DETAILED DESCRIPTION OF THE PREFERRED EMBODIMENT

The embodiments of the present application will be described in more detail below with reference to the drawings and element numerals, so that those skilled in the art to which the present application pertains can implement the present invention accordingly after studying the specification.

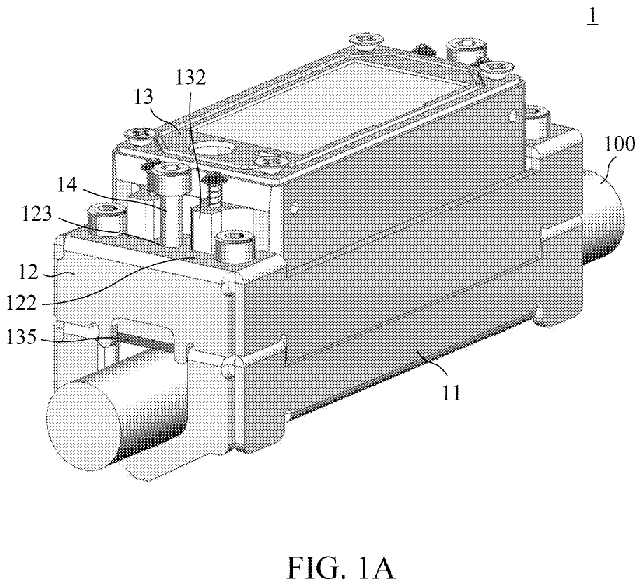

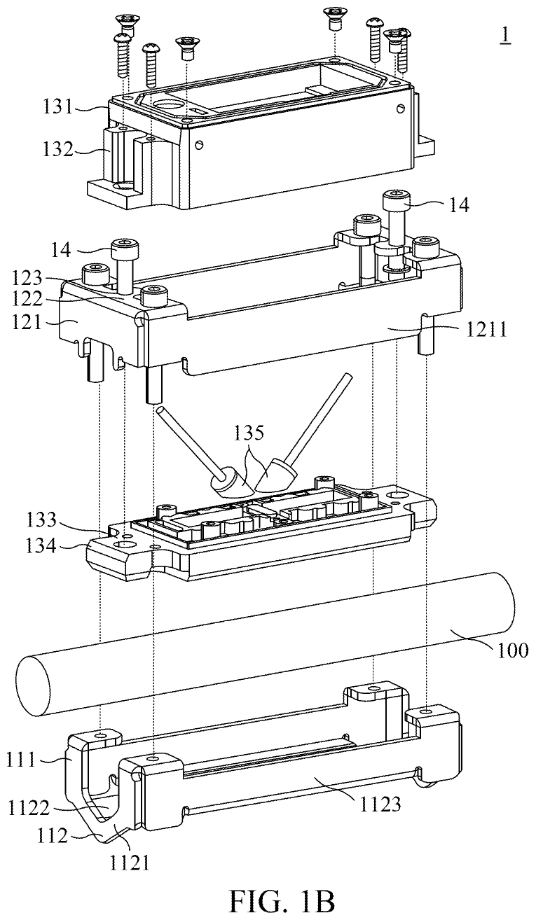

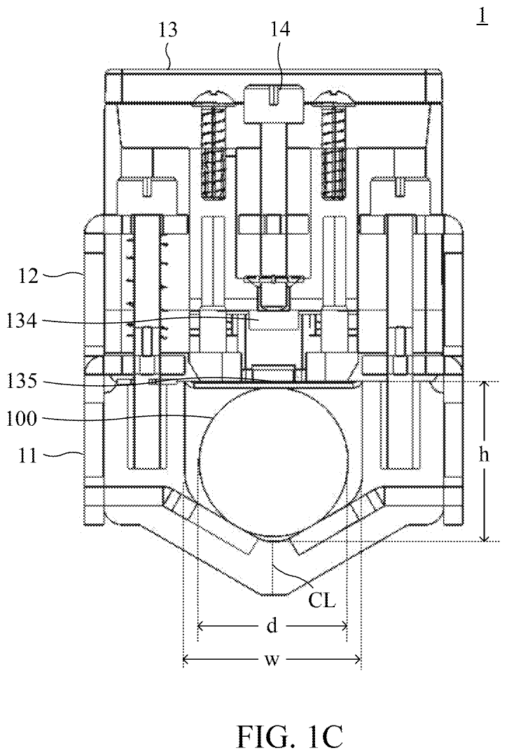

FIG. 1A is a perspective view illustrating a clamp-on ultrasonic flow meter of an embodiment of the present application, FIG. 1B is an exploded view illustrating the clamp-on ultrasonic flow meter as shown in FIG. 1A, FIG. 1C is a cross-sectional view illustrating the clamp-on ultrasonic flow meter as shown in FIG. 1A along the radial direction of the pipeline. As shown in FIG. 1A, FIG. 1B, and FIG. 1C, a clamp-on ultrasonic flow meter 1 includes a clamping part 11, a mounting case 12, a main unit 13 and fixing elements 14, the clamping part is configured to receive a pipeline 100; the mounting case 12 is detachably connected to the clamping part 11, the clamping part 11 connected to the mounting case 12 surrounds the pipeline 100 and can move axially, circumferentially or radially along the pipeline 100, the main unit 13 can be embedded into the mounting case 12; the fixing elements 14 can pass through the mounting case 12 to push the main unit 13 to move towards the clamping part 11, to allow the main unit 13 and the clamping part 11 to clamp the surface of the pipeline 100, thereby fixing the main unit 13 on the pipeline 100.

Specifically, the clamping part 11 includes vertical walls 111 and a base 112, the base 112 is connected to the vertical walls 111. The mounting case 12 includes a frame 121, guide structures 122 and through holes 123 located at two opposite inner sides of the frame 121. The main unit 13 includes a housing 131, sliding structures 132, a probe seat 133, stoppers 134 and ultrasonic probes 135, the sliding structures 132 are located at two opposite outer sides of the housing 131, the probe seat 133 is connected to lower side of the housing 131, the stoppers 134 are located at two opposite outer sides of the probe seat 133, and the ultrasonic probes 135 are disposed in the probe seat 133. The fixing elements 14 pass through the through holes 123 from upper side of the mounting case 12 and embed into the stoppers 134. By aligning the sliding structure 132 with the guide structures 122, the main unit 13 is embedded into the mounting case 12. After the pipeline 100 is placed on the base 112 and the frame 121 of the mounting case 12 is connected to vertical walls 111 of the clamping part 11, the clamping part 11 connected to the mounting case 12 surrounds the pipeline 100, and can move axially, circumferentially or radially along the pipeline 100. The main unit 13 is pushed to move towards the clamping part 11 by using the fixing elements 14, to allow lower surfaces of the ultrasonic probes 135 be firmly pressed against the surface of the pipeline 100. By the base 112 and the lower surfaces of the ultrasonic probes 135 clamp the surfaces of the pipelines, the main unit 13 is fixed on the pipeline 100.

In this embodiment, the clamping part 11 may be made of a metallic material in one-piece configuration, the clamping part 11 includes four vertical walls 111, the base 112 includes a centerline CL and four inclined surfaces 1121 symmetrical about the centerline CL, a supporting plate 1122 extending along an axial direction of the pipeline 100 to connect the inclined surfaces 1121 on both sides, and side beams 1123 extending along the axial direction of the pipe 100 to connect the vertical walls 111 on both sides. A distance w between the two vertical walls 111 located on the same radial cross-section of the pipeline 100 is not less than an outer diameter d of the pipeline 100, a height h from a plane flush with the upper edges of the two vertical walls 111 on the same radial cross-section of the pipeline 100 to a vertex of the centerline of the base 112 is greater than the outer diameter d of the pipeline 100. The pipeline 100 is placed on the base 112, such that the surfaces of the pipeline 100 on both sides of the centerline CL of the base 112 abut against the inclined surfaces 1121 and the supporting plate 1122. A user can hold the clamping part 11 with a single hand, which facilitates the subsequent assembly of the clamping part 11 and the mounting case 12. In other embodiments, the clamping part may consist of two U-shaped members, each U-shaped member includes two vertical walls and a base connecting the two vertical walls, wherein the base has two arcuate surfaces (curved surfaces) symmetrical about the centerline.

In this embodiment, the mounting case 12 may be made of a metallic material, an accommodating space is formed within the frame 121, the guide structures 122 are located on two opposite inner sides of the frame 121 along the axial direction of the pipeline 100, each of the guide structure 122 includes two grooves and a tab between the two grooves, the through hole 123 is located within the tab between the two grooves, and the through hole 123 includes a thread. The housing 131, the sliding structure 132, the probe seat 133, and stopper 134 of the main unit 13 may be made of a plastic material, the housing 131 and the sliding structure 132 are integrally formed, and the probe seat 133 and the stopper 134 are also formed in a unitary construction, the housing 131 is connected to the probe seat 133 by four screws, the sliding structure 132 includes two protrusions and a gap located between the two protrusions, the shape and position of the two protrusions of the sliding structure 132 are configured to align with the two grooves of the guide structure 122, allowing the main unit 13 to be vertically embedded into the accommodating space within the frame 121. In other embodiments, the guide structure may be a single tab or a guide groove, and the sliding structure may be a groove whose shape and position align with the tab, or a rib that aligns with the guide groove.

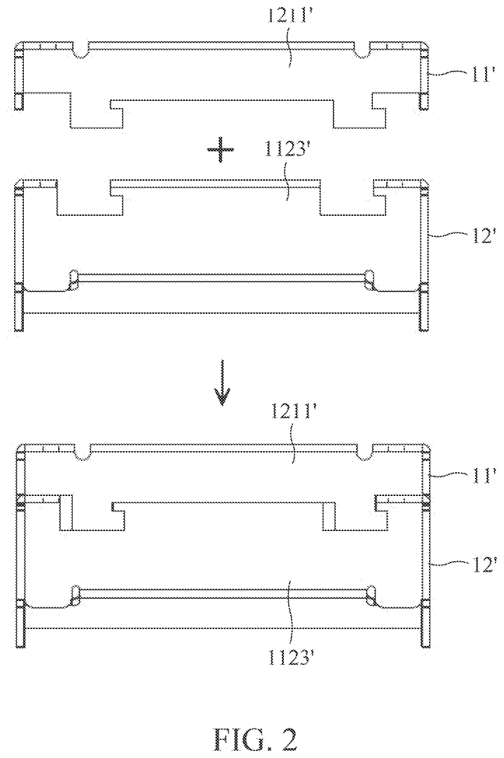

In this embodiment, through holes or threaded holes are formed on the upper sides of the four vertical walls 111 of the clamping part 11, and through holes or threaded holes are formed at the four corners of the frame 121 of the mounting case 12. After the pipe 100 is placed on the base 112 and the main unit 13 is embedded into the mounting case 12, the four through holes or threaded holes of the frame 121 are aligned with the four through holes or threaded holes of the vertical walls 111, the mounting case 12 and the clamping part 11 are then locked together using four bolts or screws until a side wall 1211 of the frame body 121, located between the two guide structures 122, abuts against the side beam 1123 of the clamping part 11 (screw-locking method), thereby completing the connection between the clamping part 11 and the mounting case 12. As shown in FIG. 2 that is a side view illustrating the clamping part 11′ and the mounting case 12′ of the other embodiment, the two side beams 1123′ of the clamping part 11′ each have two L-shaped grooves, and the two side walls 1211′ of the mounting case 12′ each have two L-shaped hooks. The two L-shaped hooks of the mounting case 12′ are first inserted into the two L-shaped grooves of the clamping part 11′, and then the four corners of the mounting case 12′ are translated until they are flush with the vertical walls of the clamping part 11′, such that the two L-shaped hooks interlock with the two L-shaped grooves (snap-fit method), thereby completing the connection between the clamping part 11′ and the mounting case 12′.

In this embodiment, the fixing element 14 is a screw-locking element, such as a screw or a bolt, two fixing elements 14 respectively pass through the through holes 123 of the mounting case 12 and the gaps of the sliding structures 132 of the main unit 13 to embed into blind holes of the stopper 134. Since the main unit 13 is only embedded into the mounting case 12 without being otherwise connected to or fixed with the clamping part 11 or the mounting case 12, as the fixing elements 14 are rotated to move downward toward the clamping part 11, the main unit 13 is pushed by the fixing elements 14 until the lower surfaces of the ultrasonic probes 135 are firmly pressed against the surface of the pipe 100. Alternatively, a user may directly push the main unit 13 downward to a position where the lower surfaces of the ultrasonic probes 135 contact the surface of the pipe 100, and then rotate the fixing elements 14 until the lower surfaces of the ultrasonic probes 135 are in close contact with the surface of the pipe 100. A distance by which the fixing element 14 passes through the through hole 123 is inversely proportional to an outer diameter of the pipe 100.

It is worth noting that existing two-piece clamps for clip-on ultrasonic flow meters apply mechanical forces in four directions on the surface of a pipe to secure themselves thereto; subsequently, screws are passed through threaded holes located above a main unit and corresponding threaded holes in a fastener below the main unit to fix the main unit to the fastener and press the lower surface of the main unit against the pipe surface, the fastening force applied by the screws to the main unit and the fastener is extremely high, creating a torque from the threaded holes above the main unit to its lower surface contacting the pipe. Since the rigidity of the metallic fastener is greater than that of the plastic housing of the main unit, the continuous fastening force and torque applied by the screws on both sides tend to cause the lower surface of the main unit to deform from a flat plane into an arch-shaped depression, this results in measurement errors and may even cause deformation or damage to the ultrasonic probes. Compared to conventional clamp-on ultrasonic flow meters, the clamping part 11, 11′ and the mounting case 12, 12′ of the present application do not apply any mechanical force to the pipe 100 during or after the connection process, the probe seat 133 and the stopper 134 below the main unit 13 are located on the same plane, the fastening force exerted by the fixing element 14 against the stopper 134 does not generate a torque on the main unit 13; furthermore, the fastening force applied by the fixing element 14 to the mounting case 12 through the through hole 123 does not act upon the main unit 13, thereby ensuring that the main unit 13 as a whole maintains its original shape and measurement accuracy.

Moreover, since the base 112 includes two inclined surfaces 1121 (or two arcuate surfaces) symmetrical about the centerline CL, the pipe 100 is necessarily positioned on the two inclined surfaces 1121 (or the two arcuate surfaces) of the base 112 in a manner symmetrical to the centerline CL, the main unit 13 is embedded into the mounting case 12 by aligning the sliding structure 132 with the guide structure 122. Once the clamp-on ultrasonic flow meter 1 is secured onto the pipe 100, the lower surfaces of the ultrasonic probes 135 are in close contact with the surface of the pipe 100 along a straight line, wherein the straight line is coplanar with the centerline CL of the base 112; that is, the straight line is equidistant from the two vertical walls 111 on opposite sides, and the pipe 100 is symmetrically positioned below the ultrasonic probes 135. When a user installs the clip-on ultrasonic flow meter 1 of the present invention, there is no need to specifically align the center of the pipe 100 with the centers of the clamping part 11 and the mounting case 12, thereby significantly enhancing the installation convenience and measurement accuracy of the clip-on ultrasonic flow meter 1.

A number of ultrasonic probes 135 can be one to three, wherein a single ultrasonic probe 135 can measure the sound speed of a liquid or utilize the Doppler effect (Doppler method) to measure the flow velocity and flow rate of the liquid within the pipeline 100, two ultrasonic probes 135 can utilize the transit-time method (time-difference method) to measure the flow velocity and flow rate of the liquid, three ultrasonic probes 135 can simultaneously measure the sound speed and utilize the transit-time method to measure the flow velocity and flow rate of the liquid. To reduce the acoustic impedance mismatch between the pipe 100 and the ultrasonic probes 135 and to enhance the transmission rate of the ultrasonic signals, the lower surfaces of the ultrasonic probes 135 may include an acoustic impedance coupling layer.

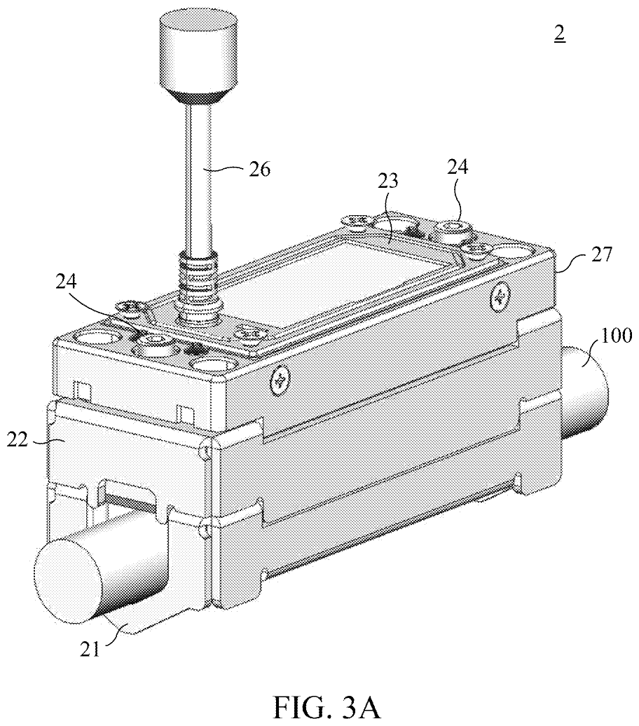

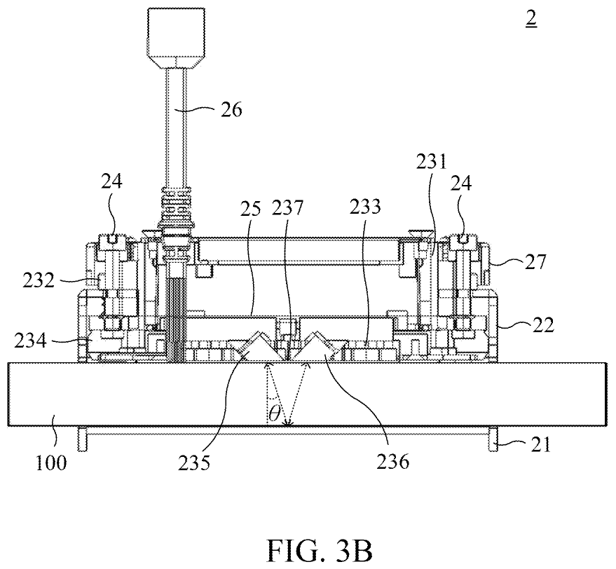

FIG. 3A is a perspective view illustrating a clamp-on ultrasonic flow meter according to another embodiment of the present application, FIG. 3B is a cross-sectional view illustrating the clamp-on ultrasonic flow meter shown in FIG. 3A along an axial direction of a pipeline. As shown in FIG. 3A and FIG. 3B, in additional to a clamping part 21, a mounting case 22, a main unit 23 and fixing elements 24, a clamp-on ultrasonic flow meter 2 further includes a circuit board 25, a power and signal cable 26 and an outer cover 27, wherein shapes, structures and functions of the clamping part 21, the mounting case 22, the main unit 23 and the fixing elements 24 are identical to those of the clamping part 11, the mounting case 12, the main unit 13 and the fixing elements 14 of aforesaid embodiment. In this embodiment, the main unit 23 includes a housing 231, sliding structures 232, a probe seat 233, stoppers 234, a first ultrasonic probe 235, a second ultrasonic probe 236 and acoustic impedance coupling layers 237, wherein the sliding structures 232 are located at two opposite outer sides of the housing 231, the probe seat 233 is connected to lower side of the housing 231, the stoppers 234 are located at two opposite outer sides of the probe seat 233, the first ultrasonic probe 235 and the second ultrasonic 236 are disposed in the probe seat 233. and the acoustic impedance coupling layers 237 are disposed on lower surfaces of the first ultrasonic probe 235 and the second ultrasonic 236. The circuit board 25 is disposed in the housing 231 and is connected to the first ultrasonic probe 235 and the second ultrasonic probe 236. The power and signal cable 26 passes through the housing 231 and is connected to the circuit board 25. The outer cover 27 is disposed on the housing 231.

The circuit board 25 is provided with a control circuit for controlling the transmission and reception of sensing signals by the ultrasonic probes, and an arithmetic circuit for calculating flow velocity and flow rate data. The power and signal cable 26 is configured to supply external power to the circuit board 25 and to transmit the flow velocity and flow rate data to an external computer device.

The outer cover 27 is a hollow cover body and has two shoulders, two side walls connecting the two shoulders, and a space defined within the shoulders and the side walls. The shoulders are disposed on the sliding structures 232 and include three through holes for the fixing elements 24 and the screws or bolts that lock the mounting case 22 to the clamping part 21 to pass through. The outer cover 27 is secured to the housing 231 by passing screws through the side walls of the outer cover 27 into threaded holes in the side walls of the housing 231. The dimensions of the outer cover 27 are flush with those of the mounting case 22. When the fixing elements 24 push the main unit 23 toward the clamping part 21, the outer cover 27 serves to limit a travel distance of the main unit 23 and define a minimum outer diameter of a pipe that can be installed. This prevents a user from over-compressing the main unit 23 and the pipeline 100, thereby avoiding deformation of the main unit 23 or the pipeline 100.

The clamp-on ultrasonic flow meter 2 utilizes the transit-time method to measure the flow velocity and flow rate of the liquid within the pipeline 100. The control circuit of the circuit board 25 controls the first ultrasonic probe 235 to transmit a first sensing signal in a direction forming an angle (oblique direction) with the radial direction of the pipeline 100, while the second ultrasonic probe 236 receives the first sensing signal. The arithmetic circuit of the circuit board 25 analyzes the transmission time of the first sensing signal from the first ultrasonic probe 235 to the second ultrasonic probe 236. Subsequently, the control circuit controls the second ultrasonic probe 236 to transmit a second sensing signal in a direction forming a symmetrical angle to the transmission angle of the first ultrasonic probe 235, while the first ultrasonic probe 235 receives the second sensing signal. The arithmetic circuit then analyzes the transmission time of the second sensing signal from the second ultrasonic probe 236 to the first ultrasonic probe 235, and generates the flow velocity and flow rate of the liquid within the pipeline 100 based on the following calculation formulas.

Calculation Formula 1:

Liquid Flow Velocity=(Transmission time difference between the first sensing signal and the second sensing signal×Square of the sound speed in liquid)/(2×Inner diameter of the pipeline×tan Θ), where Θ represents the incident angle of the first sensing signal passing through the liquid.

Calculation Formula 2:

Instantaneous Flow Rate=Liquid Flow Velocity×Radial Cross-sectional Area

In this embodiment, the power and signal cable 26 transmits data of the flow velocity and the flow rate of the liquid in the pipeline 100 to outside computer device to display the data of the flow velocity and the flow rate. In other embodiment, the clamp-on ultrasonic flow meter can further includes a display disposed on the main unit and connected to the circuit board, for displaying a flow velocity and a flow rate of the liquid in the pipeline.

In summary, the clamp-on ultrasonic flow meter of the present application includes a clamping part, a mounting case, a main unit, and a fixing element, the clamping part is configured to receive a pipeline, and the mounting case is detachably connected to the clamping part; once connected, the clamping part and the mounting case surround the pipeline and are movable in an axial, circumferential, or radial direction of the pipe without applying any mechanical force to the pipeline. The main unit is embedded into the mounting case by aligning a sliding structure of the main unit with a guide structure of the mounting case. The fixing element pushes the main unit such that a lower surface of an ultrasonic probe in the main unit and the clamping part clamp the surface of the pipe therebetween. There is no torque between the fixing element and the main unit, which effectively prevents deformation of the main unit or the pipeline caused by over-tightening of the clamping part, the mounting case, and the fixing element, while significantly enhancing the installation convenience and measurement accuracy of the clamp-on ultrasonic flow meter.

The above embodiments are merely illustratively illustrative of the principles of the present invention and its effects, and are not intended to limit the present invention. The above embodiments may be modified, combined and altered by anyone skilled in the art, without departing from the spirit and scope of the invention. Therefore, all equivalent modifications, combinations or alterations made by anyone skilled in the art without departing from the spirit and technical principles disclosed by the present invention shall remain within the following claim of the present invention.

What is claimed is:

1. A clamp-on ultrasonic flow meter, comprising:
a clamping part, configured to receive a pipeline;
a mounting case, detachably connected to the clamping part, and comprising guide structures and through holes, wherein the clamping part connected to the mounting case surrounds the pipeline and can move axially, circumferentially or radially along the pipeline;
a main unit, comprising sliding structures and an ultrasonic probe, and capable of being embedded into the mounting case by aligning the sliding structures with the guide structures; and
fixing elements, capable of passing through the through holes from an upper side of the mounting case to push the main unit to move towards the clamping part, to allow a lower surface of the ultrasonic probe and the clamping part to clamp the surface of the pipeline, thereby fixing the main unit on the pipeline.

2. The clamp-on ultrasonic flow meter according to claim 1, wherein the clamping part comprises vertical walls and a base connected to the vertical walls, a distance between the vertical walls is not less than an outer diameter of the pipeline, the base has a centerline and two inclined or arcuate surfaces symmetrical to the centerline, and the pipeline abuts against the two inclined or arcuate surfaces.

3. The clamp-on ultrasonic flow meter according to claim 1, wherein the mounting case further comprises a frame, the guide structures are located at two opposite inner sides of the frame, and each of the guide structures comprises two grooves, each of the through holes is located between the two grooves, and each of the sliding structures comprises two protrusions that align the two grooves.

4. The clamp-on ultrasonic flow meter according to claim 1, wherein the main unit comprises a housing, a probe seat connected to a lower side of the housing, and stoppers located at two opposite outer sides of the probe seat, the ultrasonic probe is disposed in the probe seat, and the fixing elements pass through the through holes from upper side of the mounting case and embed into the stoppers.

5. The clamp-on ultrasonic flow meter according to claim 1, wherein the fixing elements are screw-locking components.

6. The clamp-on ultrasonic flow meter according to claim 1, wherein the clamping part is connected to the mounting case by screw-locking or snap-fit.

7. The clamp-on ultrasonic flow meter according to claim 1, wherein a distance of the fixing element passing through the through hole is inversely proportional to an outer diameter of the pipeline.

8. The clamp-on ultrasonic flow meter according to claim 1, wherein the ultrasonic probe has an acoustic impedance coupling layer on the lower surface thereof.

9. The clamp-on ultrasonic flow meter according to claim 1, further comprising: a circuit board, a power and signal cable, and an outer cover, wherein the circuit board is disposed in the main unit, connected to the ultrasonic probe and capable of controlling the ultrasonic probe transmit and receive sensing signals; the power and signal cable is connected to the circuit board and capable of supplying an outer power to the circuit board; the outer cover is disposed on the main unit and capable of restricting a distance that the main unit moves towards the clamping part.

10. The clamp-on ultrasonic flow meter according to claim 9, further comprising: a display, disposed on the main unit and connected to the circuit board, for displaying a flow velocity and a flow rate of the liquid in the pipeline.
